(19) United States
(12) Patent Application Publication
(10) Pub. No.: US 2026/0307600 A1
(43) Pub. Date: Oct. 8, 2026

(54) MULTIPART LICENSE PLATE FRAME

(71) Applicant: Cruiser Accessories, LLC, Monument, CO (US)

(72) Inventors: Todd R. Spencer, Monument, CO (US); Mark Hunter Basenberg, JR., Colorado Springs, CO (US)

(21) Appl. No.: 19/572,772

(22) Filed: Mar. 19, 2026

Related U.S. Application Data
(60) Provisional application No. 63/784,595, filed on Apr. 7, 2025.

(51) Int. Cl. B60R 13/10; F16B 5/02

(52) U.S. Cl. CPC B60R 13/105; F16B 5/0208

(57) ABSTRACT

A multipart license plate frame is made from individual component parts. Two long strips and two short strips are connected by way of four brackets, one bracket on each adjoining corner of two abutting strips. A plurality of screws or other types of fasteners are used to connect the brackets to the strips. The four brackets have four holes that align with the four holes in a license plate that align with the four holes in the frame of an automobile so that a screw or bolt can pass through the four bracket holes through the four license plate holes and into the four holes in the frame of the automobile to secure the multipart license plate frame and license plate to the frame of the automobile.

### CROSS REFERENCE TO RELATED APPLICATION

This application claims the benefit of U.S. Provisional Patent Application Ser. No. 63/784,595 filed on Apr. 7, 2025, titled “MULTIPART LICENSE PLATE FRAME”.

### FIELD OF THE INVENTION

The invention relates to license plate frames that fit over automobile license plates.

### BACKGROUND OF THE INVENTION

Some materials that may be used in the manufacture of license plate frames are aesthetically pleasing, but very expensive. Sales in the marketplace are diminished because other license plate frames are more affordable outweighing the desire of a consumer for a more aesthetically pleasing license plate frame.

### SUMMARY OF THE INVENTION

What is needed in the field is a way to minimize waste of expensive materials to produce more aesthetically pleasing license plate frames that may be competitively priced compared to other license plate frames not made from expensive materials.

### BRIEF DESCRIPTION OF THE DRAWINGS

FIG. 1 shows an exploded perspective view of a multipart license plate frame in an embodiment of the present invention.

FIG. 2 shows a front view of the multipart license plate frame of FIG. 1 in an embodiment of the present invention.

FIG. 3 shows a back view of the multipart license plate frame of FIG. 1 in an embodiment of the present invention.

To assist in the understanding of the present disclosure the following list of components and associated numbering found in the drawings is provided herein:

Table of Components

| Component | # |
|---|---|
| multipart license plate frame | 1 |
| top strip | 2 |
| bottom strip | 4 |
| left strip | 6 |
| right strip | 8 |
| top left bracket | 10 |
| top right bracket | 12 |
| bottom right bracket | 14 |
| bottom left bracket | 16 |
| internally threaded nubs | 18 |
| matching hole | 20 |
| matching hole | 22 |
| screws | 24 |
| internally threaded nubs | 26 |
| matching hole | 28 |
| matching hole | 30 |
| screws | 32 |
| internally threaded nubs | 34 |
| matching hole | 36 |
| matching hole | 38 |
| screws | 40 |
| internally threaded nubs | 42 |
| matching hole | 44 |
| matching hole | 46 |
| screws | 48 |
| hole | 50 |
| hole | 52 |
| hole | 54 |
| hole | 56 |

### DETAILED DESCRIPTION

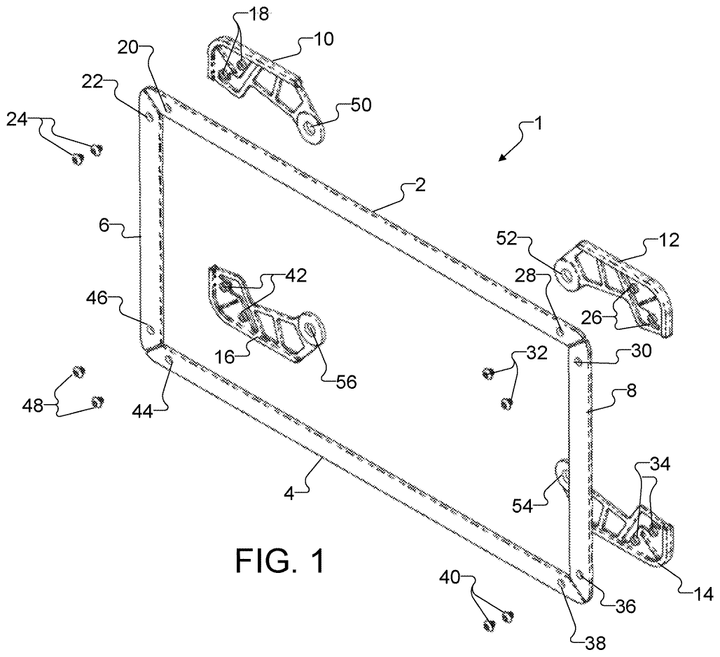

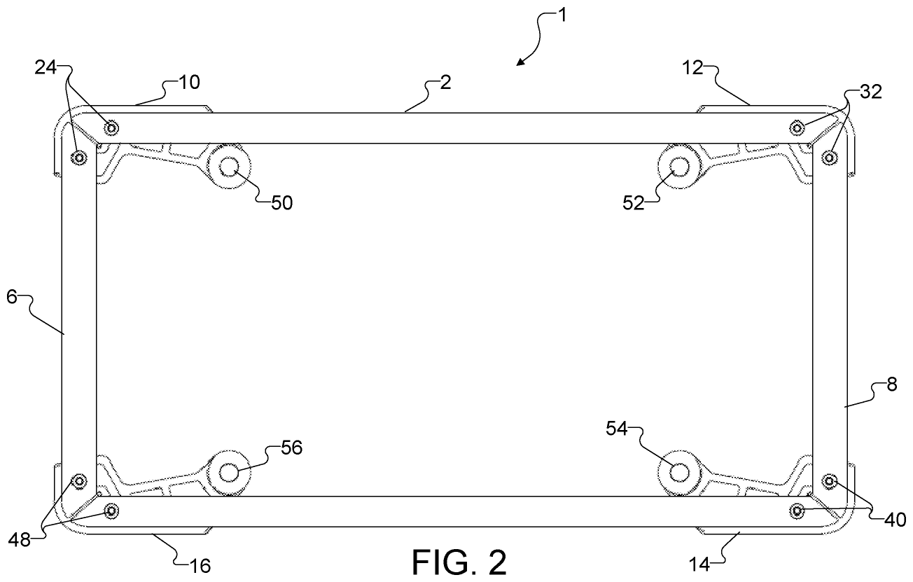

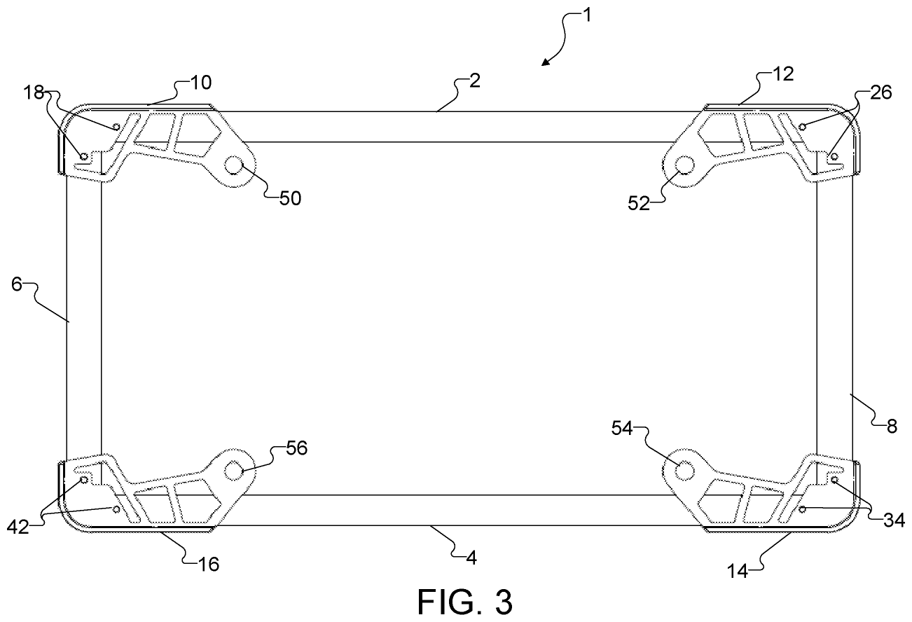

Referring now to the Figures, in which like reference numerals refer to structurally and/or functionally similar elements thereof, FIG. 1 shows an exploded perspective view of a multipart license plate frame in an embodiment of the present invention. FIG. 2 shows a front view of the multipart license plate frame of FIG. 1 in an embodiment of the present invention. FIG. 3 shows a back view of the multipart license plate frame of FIG. 1 in an embodiment of the present invention. Referring now to FIGS. 1, 2, and 3, multipart license plate frame 1 is made up of several components including top strip 2, bottom strip 4, left strip 6, and right strip 8. In the embodiment shown all the ends of all the strips 2/4/6/8 are angled at 45° so that when abutted against each other they form a substantially seamless appearance. One skilled in the art will recognize that other abutment configurations are possible, such as square ends where the length of one strip abuts squarely with an end of an adjoining strip.

Top left bracket 10 is used to secure left strip 6 to top strip 2. Top right bracket 12 is used to secure top strip 2 to right strip 8. Bottom right bracket 14 is used to secure right strip 8 to bottom strip 4. Bottom left bracket 16 is used to secure bottom strip 4 to left strip 6. Top left bracket 10 is the same shape as bottom right bracket 14. Top right bracket 12 is the same shape as bottom left bracket 16.

Top left bracket 10 has a pair of internally threaded nubs 18 that align with a matching hole 20 in in top strip 2 and a matching hole 22 in left strip 6. A pair of screws 24 pass through matching holes 20/22 and engage with internally threaded nubs 18. When tightened, the pair of screws 24 secure top strip 2 and left strip 6 together.

Top right bracket 12 has a pair of internally threaded nubs 26 that align with a matching hole 28 in in top strip 2 and a matching hole 30 in right strip 8. A pair of screws 32 pass through matching holes 28/30 and engage with internally threaded nubs 26. When tightened, the pair of screws 32 secure top strip 2 and right strip 8 together.

Bottom right bracket 14 has a pair of internally threaded nubs 34 that align with a matching hole 36 in in right strip 8 and a matching hole 38 in bottom strip 4. A pair of screws 40 pass through matching holes 36/38 and engage with internally threaded nubs 34. When tightened, the pair of screws 40 secure right strip 8 and bottom strip 4 together.

Bottom left bracket 16 has a pair of internally threaded nubs 42 that align with a matching hole 44 in in bottom strip 4 and a matching hole 46 in left strip 6. A pair of screws 48 pass through matching holes 44/46 and engage with internally threaded nubs 42. When tightened, the pair of screws 48 secure left strip 6 and bottom strip 4 together.

Top left bracket 10 has a hole 50. Top right bracket 12 has a hole 52. Bottom right bracket 14 has a hole 54. Bottom left bracket 16 has a hole 56. Holes 50/52/54/56 align with four holes in a license plate (not shown) that also align with four internally threaded holes in the frame of an automobile (not shown) so that four screws (not shown) are passed through each hole 50/52/54/56 and through the four holes in the license plate and into the internally threaded holes in the frame of the automobile to secure multipart license plate frame 1 and the license plate to the frame of the automobile.

In one embodiment, top strip 2, bottom strip 4, left strip 6, and right strip 8 are made from forged carbon fiber. Forged carbon fiber is very expensive. Forging slim, rectangular strips 2/4/6/8 produces much less waste than forging a unitary license plate frame with the brackets in which the entire open area within the frame edges and around the brackets are cut out and wasted but still must be paid for. Forging slim rectangular strips 2/4/6/8 thus reduces costs significantly.

In one embodiment, top left bracket 10, top right bracket 12, bottom right bracket 14, and bottom left bracket 16 are made from forged aluminum. In another embodiment brackets 10/12/14/16 are made from zinc. In another embodiment brackets 10/12/14/16 are made from powder-coated steel. In another embodiment brackets 10/12/14/16 are made from anodized aluminum. The different materials used for the brackets 10/12/14/16 achieve a contrasting appearance to the dark carbon fiber strips 2/4/6/8 creating different aesthetic looks, mimicking the appearance of a functional race car part, like a rear spoiler or other structural race car part.

In another embodiment the top strip 2, bottom strip 4, left strip 6, and right strip 8 are made from polycarbonate. The screws 24/32/40/48 are made of stainless steel. In another embodiment, rivets (not shown) may be used instead of screws. One skilled in the art will recognize that other types of fasteners made from different materials may be used within the scope of this disclosure.

In one embodiment, the multipart license plate frame 1 is assembled and packaged prior to sale. In another embodiment, the multipart license plate frame 1 is packaged unassembled and sold as a kit and the buyer is responsible for assembling the parts of the multipart license plate frame 1. This further reduces the cost to make the multipart license plate frame 1 even more competitively priced to other license plates made from less expensive materials.

Having described the present invention, it will be understood by those skilled in the art that many changes in construction and widely differing embodiments and applications of the invention will suggest themselves without departing from the scope of the present invention.

What is claimed is:

1. A method for assembling a license plate frame kit comprising:
providing a left strip, a top strip, a right strip, and a bottom strip;
providing a first bracket and connecting the first bracket to the left strip and to the top strip;
providing a second bracket and connecting the second bracket to the top strip and to the right strip;
providing a third bracket and connecting the third bracket to the right strip and to the bottom strip; and
providing a fourth bracket and connecting the fourth bracket to the bottom strip and to the left strip.

2. A method for assembling a license plate frame kit according to claim 1 further comprising:
provisioning a first hole in the first bracket;
provisioning a second hole in the second bracket;
provisioning a third hole in the third bracket; and
provisioning fourth hole in the fourth bracket;
wherein the first hole and the second hole and the third hole and the fourth hole are each aligned with a four holes respectively in a license plate wherein the four holes in the license plate are aligned with a four internally threaded holes in a frame of an automobile.

3. The method for assembling a license plate frame kit according to claim 1 further comprising:
configuring the first bracket with a first pair of internally threaded nubs;
configuring the second bracket with a second pair of internally threaded nubs;
configuring the third bracket with a third pair of internally threaded nubs; and
configuring the fourth bracket with a fourth pair of internally threaded nubs.

4. The method for assembling a license plate frame kit according to claim 3 further comprising:
aligning the first pair of internally threaded nubs with respectively a first matching hole in the left strip and a first matching hole in the top strip;
aligning the second pair of internally threaded nubs with respectively a second matching hole in the top strip and a first matching hole in the right strip;
aligning the third pair of internally threaded nubs with respectively a second matching hole in the right strip and a first matching hole in the bottom strip; and
aligning the fourth pair of internally threaded nubs with respectively a second matching hole in the bottom strip and a second matching hole in the left strip.

5. The method for assembling a license plate frame kit according to claim 4 further comprising:
passing a first pair of screws through respectively the first matching hole in the left strip and the first matching hole in the top strip and screwing into the first pair of internally threaded nubs in the first bracket thereby securing the left strip and the top strip together;
passing a second pair of screws through respectively the second matching hole in the top strip and the first matching hole in the right strip and screwing into the second pair of internally threaded nubs in the second bracket thereby securing the top strip and the right strip together;
passing a third pair of screws through respectively the second matching hole in the right strip and the first matching hole in the bottom strip and screwing into the third pair of internally threaded nubs in the third bracket thereby securing the right strip and the bottom strip together; and
passing a fourth pair of screws through respectively the second matching hole in the bottom strip and the second matching hole in the left strip and screwing into the fourth pair of internally threaded nubs in the fourth bracket thereby securing the bottom strip and the left strip together.

6. A license plate frame comprising:
a left strip;
a top strip;
a right strip;
a bottom strip;
a first bracket connected to the left strip and the top strip;
a second bracket connected to the top strip and the right strip;
a third bracket connected to the right strip and the bottom strip; and
a fourth bracket connected to the bottom strip and the left strip.

7. The license plate frame according to claim 6 further comprising:
a first hole in the first bracket;
a second hole in the second bracket;
a third hole in the third bracket; and
a fourth hole in the fourth bracket;
wherein the first hole and the second hole and the third hole and the fourth hole are configured to each align with a four holes respectively in a license plate wherein the four holes in the license plate align with a four internally threaded holes in a frame of an automobile.

8. The license plate frame according to claim 6 further comprising:
a first pair of internally threaded nubs in the first bracket;
a second pair of internally threaded nubs in the second bracket;
a third pair of internally threaded nubs in the third bracket; and
a fourth pair of internally threaded nubs in the fourth bracket;
wherein the first pair of internally threaded nubs align with respectively a first matching hole in the left strip and a first matching hole in the top strip;
the second pair of internally threaded nubs align with respectively a second matching hole in the top strip and a first matching hole in the right strip;
the third pair of internally threaded nubs align with respectively a second matching hole in the right strip and a first matching hole in the bottom strip; and
the fourth pair of internally threaded nubs align with respectively a second matching hole in the bottom strip and a second matching hole in the left strip.

9. The license plate frame according to claim 8 further comprising:
a first pair of screws that pass through respectively the first matching hole in the left strip and the first matching hole in the top strip and screw into the first pair of internally threaded nubs in the first bracket thereby securing the left strip and the top strip together;
a second pair of screws that pass through respectively the second matching hole in the top strip and the first matching hole in the right strip and screw into the second pair of internally threaded nubs in the second bracket thereby securing the top strip and the right strip together;
a third pair of screws that pass through respectively the second matching hole in the right strip and the first matching hole in the bottom strip and screw into the third pair of internally threaded nubs in the third bracket thereby securing the right strip and the bottom strip together; and
a fourth pair of screws that pass through respectively the second matching hole in the bottom strip and the second matching hole in the left strip and screw into the fourth pair of internally threaded nubs in the fourth bracket thereby securing the bottom strip and the left strip together.

10. The license plate frame according to claim 9 wherein the first pair of screws and the second pair of screws and the third pair of screws and the fourth pair of screws are made from stainless steel.

11. The license plate frame according to claim 6 wherein the left strip and the top strip and the right strip and the bottom strip are made from stainless steel.

12. The license plate frame according to claim 6 wherein the top strip and the bottom strip and the left strip and the right strip are made from polycarbonate.

13. The license plate frame according to claim 6 wherein the first bracket and the second bracket and the third bracket and the fourth bracket are made from forged aluminum.

14. The license plate frame according to claim 6 wherein the first bracket and the second bracket and the third bracket and the fourth bracket are made from zinc.

15. The license plate frame according to claim 6 wherein the first bracket and the second bracket and the third bracket and the fourth bracket are made from powder coated steel.

16. The license plate frame according to claim 6 wherein the first bracket and the second bracket and the third bracket and the fourth bracket are made from anodized aluminum.
